(19) United States
(12) Patent Application Publication
(10) Pub. No.: US 2014/0192829 A1
(43) Pub. Date: Jul. 10, 2014

(54) MULTI-CRYSTAL FREQUENCY TRIPLER FOR THIRD HARMONIC CONVERSION

(71) Applicants: Mark K. Henesian, Livermore, CA (US); Amber L. Bullington, Livermore, CA (US); Kenneth R. Manes, Brentwood, CA (US); Mary L. Spaeth, Brentwood, CA (US); Robert Deri, Pleasanton, CA (US); Chris A. Ebbers, Pleasanton, CA (US)

(72) Inventors: Mark K. Henesian, Livermore, CA (US); Amber L. Bullington, Livermore, CA (US); Kenneth R. Manes, Brentwood, CA (US); Mary L. Spaeth, Brentwood, CA (US); Robert Deri, Pleasanton, CA (US); Chris A. Ebbers, Pleasanton, CA (US)

(21) Appl. No.: 13/884,598

(22) PCT Filed: Nov. 8, 2011
(86) PCT No.: PCT/US11/59777

§ 371 Date: Mar. 4, 2014

Related U.S. Application Data
(60) Provisional application No. 61/411,754, filed on Nov. 9, 2010.

(51) Int. Cl. G02F 1/35; G02F 1/355; H01S 3/109

(52) U.S. Cl. CPC G02F 1/3532; H01S 3/109; G02F 1/3551
USPC 372/22; 359/329

(57) ABSTRACT

An optical system includes a laser source operable to output a laser beam at a fundamental wavelength and a frequency conversion system. The frequency conversion system includes a frequency doubler module including a first plurality of nonlinear optical crystals and a frequency polarization tripler module including a second plurality of nonlinear optical crystals. The optical system also includes a control system coupled to the frequency conversion system and a diagnostics system coupled to the frequency conversion system.

### CROSS-REFERENCES TO RELATED APPLICATIONS

This application claims priority to U.S. Provisional Patent Application No. 61/411,754, filed Nov. 9, 2010, the disclosure of which is hereby incorporated by reference in its entirety for all purposes.

The following PCT applications (including this one) are being filed concurrently, and the entire disclosure of the other application is incorporated by reference into this application for all purposes:
Application No. PCT/US11______, filed Nov. 8, 2011 entitled “MULTI-CRYSTAL FREQUENCY TRIPLER FOR THIRD HARMONIC CONVERSION” (Client Reference No. IL-12360; Attorney Docket No. 91920-825120(006610PC)); and
Application No. PCT/US11/59688, filed Nov. 8, 2011 entitled “METHOD OF PULSE REFORMATTING FOR OPTICAL AMPLIFICATION AND FREQUENCY CONVERSION” (Client Reference No. IL-12359; Attorney Docket No. 91920-824881(006010PC)).

### STATEMENT AS TO RIGHTS TO INVENTIONS MADE UNDER FEDERALLY SPONSORED RESEARCH OR DEVELOPMENT

The United States Goverment has rights in this invention pursuant to Contract No. DE-AC52-07NA27344 between the U.S. Department of Energy and Lawrence Livermore National Security, LLC, for the operation of Lawrence Livermore National Laboratory.

### BACKGROUND OF THE INVENTION

Projections by the Energy Information Agency and current Intergovernmental Panel on Climate Change (IPCC) scenarios expect worldwide electric power demand to double from its current level of about 2 terawatts electrical power (TWe) to 4 TWe by 2030, and could reach 8-10 TWe by 2100. They also expect that for the next 30 to 50 years, the bulk of the demand of electricity production will be provided by fossil fuels, typically coal and natural gas. Coal supplies 41% of the world's electric energy today, and is expected to supply 45% by 2030. In addition, the most recent report from the IPCC has placed the likelihood that man-made sources of CO₂ emissions into the atmosphere are having a significant effect on the climate of planet earth at 90%. “Business as usual” baseline scenarios show that CO₂ emissions could be almost two and a half times the current level by 2050. More than ever before, new technologies and alternative sources of energy are essential to meet the increasing energy demand in both the developed and the developing worlds, while attempting to stabilize and reduce the concentration of CO₂ in the atmosphere and mitigate the concomitant climate change.

Nuclear energy, a non-carbon emitting energy source, has been a key component of the world's energy production since the 1950's, and currently accounts for about 16% of the world's electricity production, a fraction that could—in principle—be increased. Several factors, however, make its long-term sustainability difficult. These concerns include the risk of proliferation of nuclear materials and technologies resulting from the nuclear fuel cycle; the generation of long-lived radioactive nuclear waste requiring burial in deep geological repositories; the current reliance on the once through, open nuclear fuel cycle; and the availability of low cost, low carbon footprint uranium ore. In the United States alone, nuclear reactors have already generated more than 55,000 metric tons (MT) of spent nuclear fuel (SNF). In the near future, we will have enough spent nuclear fuel to fill the Yucca Mountain geological waste repository to its legislated limit of 70,000 MT.

Fusion is an attractive energy option for future power generation, with two main approaches to fusion power plants now being developed. In a first approach, Inertial Confinement Fusion (ICF) uses lasers, heavy ion beams, or pulsed power to rapidly compress capsules containing a mixture of deuterium (D) and tritium (T). As the capsule radius decreases and the DT gas density and temperature increase, DT fusion reactions are initiated in a small spot in the center of the compressed capsule. These DT fusion reactions generate both alpha particles and 14.1 MeV neutrons. A fusion burn front propagates from the spot, generating significant energy gain. A second approach, magnetic fusion energy (MFE) uses powerful magnetic fields to confine a DT plasma and to generate the conditions required to sustain a burning plasma and generate energy gain.

Important technology for ICF is being developed primarily at the National Ignition Facility (NIF) at Lawrence Livermore National Laboratory (LLNL), assignee of this invention, in Livermore, Calif. There, a laser-based ICF project designed to achieve thermonuclear fusion ignition and burn utilizes laser energies of 1 to 2 MJ. Fusion yields of the order of 10 to 20 MJ are expected. Fusion yields in excess of 200 MJ are expected to be required in a central hot spot fusion geometry if fusion technology, by itself, were to be used for cost effective power generation. Thus, significant technical challenges remain to achieve an economy powered by pure ICF energy.

In addition to ICF applications, there is broad interest in the area of high average power lasers for materials processing, drilling, cutting and welding, military applications, and the like. Frequency conversion of laser light can improve absorption coefficients in materials being processed or used in systems. Despite the progress made in high average power lasers and frequency conversion of output beams from such lasers, there is a need in the art for improved methods and systems related to lasers and frequency conversion.

### SUMMARY OF THE INVENTION

According to the present invention, techniques related to optical systems are provided. More particularly, embodiments of the present invention relate to methods and systems for frequency converting laser input light. In a particular embodiment, a multi-crystal frequency converter system is provided with a unique angle tuning system for improved conversion efficiency of laser pulses that cover a wide range of intensity. The methods and systems described herein are applicable to a variety of laser and amplifier systems including high repetition rate, high average power lasers and amplifiers. The terminology “harmonic conversion” and “frequency conversion” as utilized herein refers to the process of frequency converting a laser beam at a fundamental frequency or wavelength to higher harmonics of the fundamental, such as the second, third and fourth harmonic.

The present invention relates to a frequency tripling system that is suitable for use with high power laser and amplifier systems and is characterized by high energy conversion efficiency. The frequency conversion system described herein is useful to a wide variety of laser applications including the inertial confinement fusion (ICF) laser for the Laser Inertial Fusion Energy (LIFE) system under development by the present assignee. A particular embodiment of the present invention described herein utilizes low absorption loss, highly deuterated potassium dihydrogen phosphate (DKDP) crystals with large apertures (typically 40×40 cm). However, embodiments of the present invention are not limited to this particular nonlinear crystal and other suitable nonlinear optical materials such as yttrium calcium oxyborate (YCOB) and lithium triborate (LBO) can be utilized, or crystals isomorphic to KDP and DKDP.

As described more fully throughout the present specification, some embodiments of the present invention utilize four and up to six crystals arranged in a “cascade” configuration including either type I or type II phase matching. In a particular embodiment, two or more second-harmonic generating crystals are optically coupled to two or more frequency mixing crystals, thereby providing a high power and high energy third harmonic beam of uniform polarization. In order to accommodate high repetition rates (e.g., up to 15 Hz in the LIFE application), embodiments utilize helium or other inert gas cooling of the crystal faces, either directed or guided by sapphire and/or fused silica optical plates in close proximity to the faces, or directly bonded to the faces. These plates may serve as windows. In addition, for ICF laser drivers, a continuous random phase aberration plate may be inserted between the second harmonic and third harmonic sections, patterned on a separate optical substrate or on one of the optical windows.

According to an embodiment of the present invention, a frequency conversion system is provided. The frequency conversion system includes a frequency doubler module disposed along a beam path and comprising a first plurality of non-linear crystals and a frequency tripler module disposed along the beam path and comprising a second plurality of non-linear crystals.

According to another embodiment of the present invention, a method of generating frequency converted light is provided. The method includes providing an input beam characterized by a fundamental wavelength and frequency converting a portion of the input beam to a doubled beam characterized by a doubled wavelength half the fundamental wavelength. Frequency converting the input beam includes transmitting the input beam through a first plurality of non-linear optical crystals and outputting the doubled beam and another portion of the input beam. The method also includes frequency converting the doubled beam and the another portion of the input beam to a tripled beam characterized by a tripled wavelength two thirds the doubled wavelength. Frequency converting the doubled beam and the remaining portion of the input beam comprises transmitting the doubled beam light and the remaining portion of the input beam through a second plurality of non-linear optical crystals and outputting the tripled beam.

According to a specific embodiment of the present invention, an optical system is provided. The optical system includes a laser source operable to output a laser beam at a fundamental wavelength and a frequency conversion system. The frequency conversion system includes a frequency doubler module including a first plurality of nonlinear optical crystals and a frequency tripler module including a second plurality of nonlinear optical crystals. The optical system also includes a control system coupled to the frequency conversion system and a diagnostics system coupled to the frequency conversion system.

Embodiments of the present invention are useful in a variety of laser systems, particularly, laser and amplifier systems that provide high power and high energy conversion efficiency at the third harmonic wavelength (e.g., 351 nm for Nd-based gain medium). These systems include, without limitation, ICF laser drivers for LIFE power plants, laser drivers for ICF experiments, lasers used to generate plasmas for high energy density studies, high repetition rate, high average power frequency converted lasers for materials processing, and the like.

Numerous benefits are achieved by way of the present invention over conventional techniques. For example, embodiments of the present invention provide methods and systems characterized by higher conversion efficiency than conventional systems. Additionally, embodiments enable thermal management of the frequency conversion crystals using one or more of several cooling architectures. These and other embodiments of the invention along with many of its advantages and features are described in more detail in conjunction with the text below and attached figures.

### BRIEF DESCRIPTION OF THE DRAWINGS

FIG. 1 is a simplified plot illustrating a combined pulse shape according to an embodiment of the present invention;

FIG. 2 is a simplified schematic diagram of a multi-crystal frequency conversion system according to an embodiment of the present invention;

FIG. 3 is a simplified schematic diagram illustrating a laser system utilizing a frequency converter according to an embodiment of the present invention;

FIG. 4 is a simplified plot illustrating a temperature differential as a function of flaw radius according to an embodiment of the present invention;

FIG. 5 is a simplified flowchart illustrating a method of frequency converting a laser input beam according to an embodiment of the present invention;

FIG. 6 is a simplified schematic diagram illustrating an optical system according to an embodiment of the present invention;

FIG. 7A is a simplified schematic diagram illustrating crystal angle tuning in a parallel Z configuration for either a pair of doubling or tripling crystals according to an embodiment of the present invention;

FIG. 7B is a simplified schematic diagram illustrating crystal angle tuning in an alternate Z configuration for either a pair of doubling or tripling crystals according to an embodiment of the present invention;

FIG. 8A is a simplified schematic diagram illustrating crystal angle tuning in a parallel Z configuration for either a triplet of doubling or tripling crystals according to an embodiment of the present invention;

FIG. 8B is a simplified schematic diagram illustrating crystal angle tuning in an alternate Z configuration for either a triplet of doubling or tripling crystals according to an embodiment of the present invention;

FIG. 9 is a simplified schematic diagram of a four crystal frequency tripling system including type I phase-matched frequency doubling and type II phase-matched tripling;

FIG. 10 is a simplified schematic diagram of a six crystal frequency tripling system including type I phase-matched frequency doubling and type II phase-matched tripling;

FIG. 11 is a simplified schematic diagram of a four crystal frequency tripling system including type II phase-matched frequency doubling and tripling according to an embodiment of the present invention; and

FIG. 12 a simplified schematic diagram of a four crystal frequency tripling system including type II phase-matched frequency doubling and tripling according to an embodiment of the present invention; and

### DETAILED DESCRIPTION OF THE INVENTION

According to the present invention, techniques related to optical systems are provided. More particularly, embodiments of the present invention relate to methods and systems for frequency converting laser input light, also referred to as the process of harmonic conversion. In a particular embodiment, a multi-crystal frequency converter system is provided with a unique angle tuning scheme for improved conversion efficiency. The methods and systems described herein are applicable to a variety of laser and amplifier systems including high repetition rate, high average power lasers and amplifiers.

It has been demonstrated that frequency conversion of the fundamental wavelength at 1053 nm (1ω) to the second and third harmonic wavelengths of 527 nm (2ω) and 351 nm (3ω), respectively, in ICF systems allows for more efficient absorption of laser energy by the target. This frequency conversion process increases the efficiency of the laser target coupling for the direct or indirect compression (via x-rays) of inertially confined targets for nuclear fusion. The energy conversion efficiency of the fundamental light to the third harmonic, pulse shaping fidelity over a wide intensity range, precision of pulse timing, and creating the required peak third harmonic power at the target plane are important aspects of the LIFE system.

Embodiments of the present invention provide a multi-crystal architecture for efficiently converting the desired pulse shape for the LIFE system at the third harmonic wavelength using highly deuterated potassium dihydrogen phosphate (DKDP) crystals. Highly deuterated KDP is a non-linear optical material useful for frequency conversion in high-energy, high-peak power, and high average power laser and amplifier systems because of its potential low absorption and relatively low transverse stimulated Raman gain compared to conventional KDP and other harmonic crystals. Crystal sapphire or fused silica windows in close proximity to the DKDP crystals form cooling channels for flowing helium or other inert gas, or when bonded directly to the crystal surfaces, can extract heat due to absorption into the cooling channel. Other harmonic generation crystals can be used in alternative embodiments of the present invention, for example, YCOB for second harmonic conversion and/or LBO for second and third harmonic conversion and the discussion provided herein in relation to type I and type II phase matching and beam polarization as applied to DKDP is generally applicable to these alternative non-linear optical materials, including crystals isomorphic to KDP and DKDP.

As described more fully throughout the present specification, the multi-crystal frequency tripling architectures discussed herein provide frequency conversion systems with energy conversion efficiencies of 70% or greater, with temporally shaped optical pulses over wide intensity ranges, which are suitable for use in a variety of high-energy laser and amplifier systems including the LIFE system. Although some embodiments of the present invention are described in relation to four crystal or six crystal frequency tripling architectures, the present invention is not limited to these particular architectures and other embodiments utilize two or more second-harmonic generating crystals that are followed by two or more frequency mixing crystals in a “cascade” configuration, to provide the high-power and high-energy third harmonic beam in a high average power design as well as address thermal and stress management issues during high-average-power operation.

Embodiments of the present invention provide multi-crystal frequency tripler designs with pulse shape and beam mapping for optimized energy conversion efficiency to the third harmonic for laser systems.

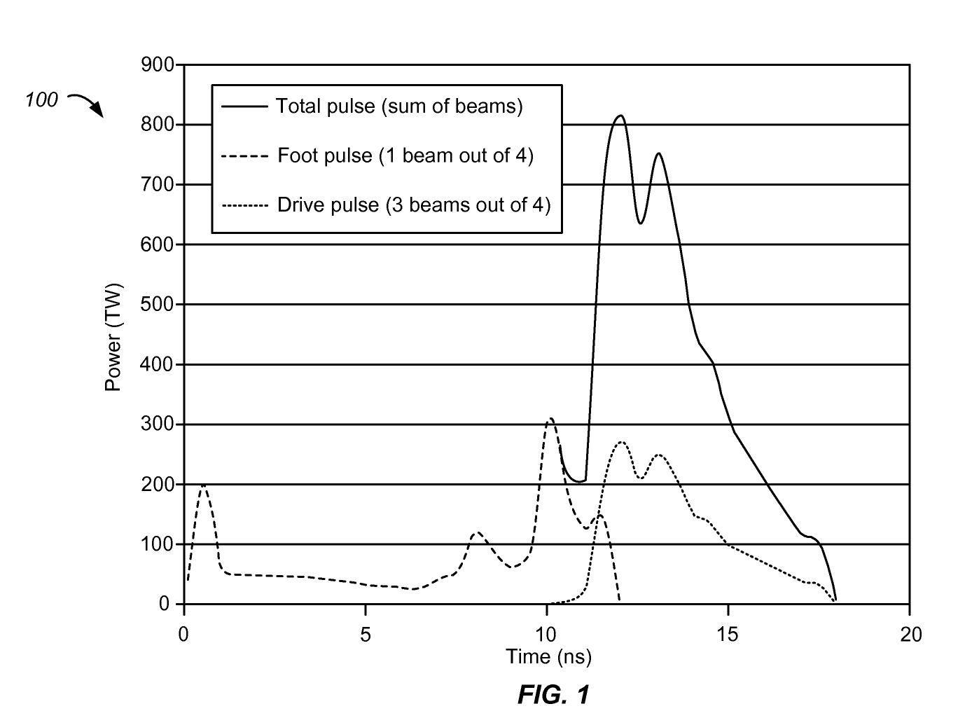

FIG. 1 is a simplified plot illustrating a combined pulse shape according to an embodiment of the present invention. The combined pulse shape (i.e. the third harmonic pulse) delivered to the target includes separate foot and drive portions that are combined to form the combined pulse shape. In this example, the foot and drive portions are mapped to individual LIFE beamlines and traverse separate amplifier and frequency converter modules in a ratio of one “foot” pulse for every three “drive” pulses. Other ratios of foot to drive pulses can be utilized according to alternative embodiments of the present invention.

Since the “foot” and “drive” pulses (considered separately) have similar peak intensities, a frequency converter can be designed to reach optimal efficiency as compared to frequency converting the “total” pulse with one converter. It should be noted that the focal planes of each pulse overlap on the target for the integrated pulse shape to match the pulse shape determined using ICF target physics. The overall energy conversion efficiency is thus the average of three times the “drive” converter efficiency plus one times the “foot” converter efficiency. A continuous random optical phase plate (CPP) maybe located between the second and third harmonic sections, and serves to homogenize the overlapped focal distributions of the “foot” and “drive” beams at the target plane, thus improving the “total” pulse shape fidelity required for ICF physics. Additional description related to the “foot” and “drive” pulses is provided in commonly assigned U.S. patent application Ser. No. 13/______ (Client Reference No. IL-12359; Attorney Docket No. 91920-795275(006010US)), incorporated by reference above.

In an embodiment, the “foot” and “drive” beam frequency converters are optimized with identical crystal phase-match types and thicknesses in order to provide interchangeability in the LIFE facility. The inventors have determined that an increase in overall energy conversion on the order of 2-3% can be achieved with individual optimized frequency converter designs for “foot” and “drive” beams and such designs can be utilized if the interchangeability of final harmonic components is not judged to be of higher systems engineering value. One of ordinary skill in the art would recognize many variations, modifications, and alternatives.

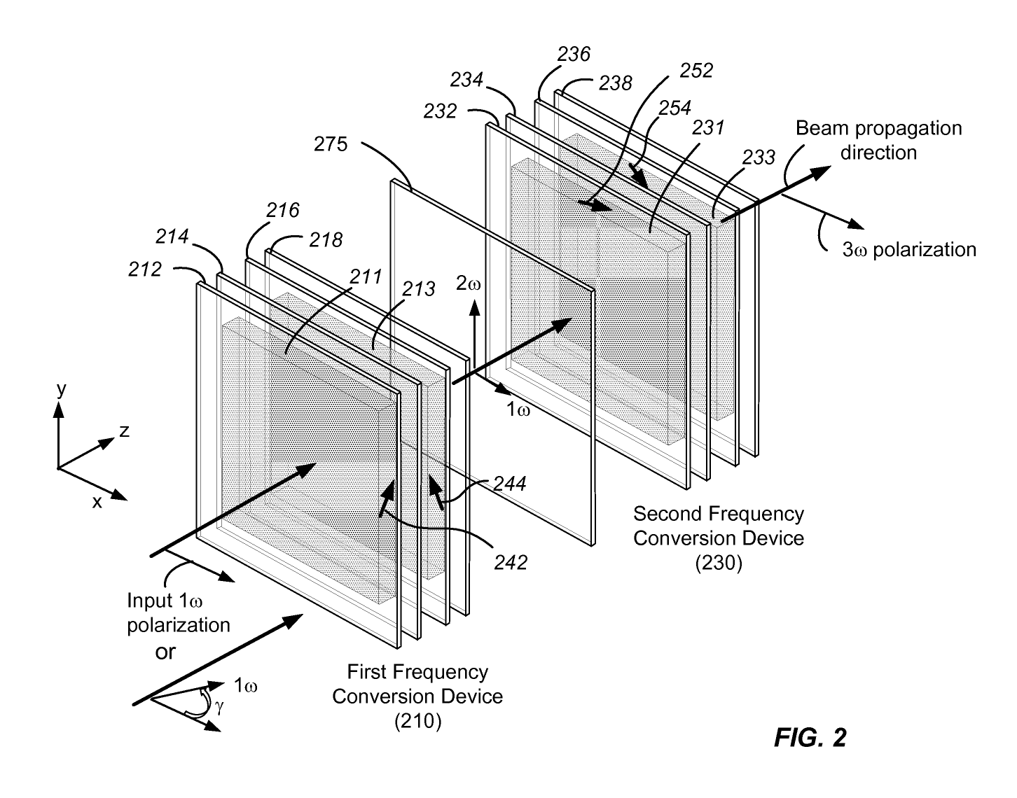

FIG. 2 is a simplified schematic diagram of a multi-crystal frequency conversion system (e.g., a KDP/DKDP-based frequency conversion system) according to an embodiment of the present invention. As illustrated in FIG. 2, a first frequency conversion device 210 (i.e., a pair of Type I of Type II doublers 211 and 213) and a second frequency conversion device 230 (i.e., a pair of Type II triplers 231 and 233) are illustrated as components of a frequency conversion system. The first frequency conversion device 210 can be referred to as a frequency doubler module or a second harmonic module and the second frequency conversion device 230 can be referred to as a frequency tripler module or a third harmonic module. Although a pair of doublers and a pair of triplers are illustrated, this particular number of doublers and triplers is not required by the present invention and other numbers, including a single doubler or more than two doublers as well as a single tripler or more than two triplers are included within the scope of the present invention. As an example, in order to reduce the thermal load in either the first doubler crystal or the first tripler crystal, each of these crystals may be replaced with two crystals that are thinner than the original crystal. It should be noted that in the schematic diagram illustrated in FIG. 2, a predetermined separation is illustrated between the frequency conversion units 210 and 230 (i.e., the set of doublers and the set of triplers). In actual implementations, the actual space will typically be less than that illustrated, indicating that the drawing is not drawn to scale. As an example, either the frequency doubler module 210 or the frequency tripler module 230 could utilize a set of three non-linear optical crystals in which a thickness of a first crystal of the set of three non-linear optical crystals is less than a thickness of a second crystal of the set of three non-linear optical crystals. Using a doubler as an example, the first crystal is thinner than the second crystal since the amount of 1ω light in the first crystal is greater than the amount of 1ω light in the second crystal as a result of the “cascaded” frequency doubling. Accordingly, the thermal load due to absorption of the lw light is decreased in the first crystal by decreasing its thickness relative to the second or subsequent doubling crystals. In this analysis, the absorption of the fundamental light is dominant in DKDP, as compared to the second or third harmonic light, which is demonstrated by experimental data.

In some embodiments, heat is removed from the components by flowing a cooling fluid in the space between the components, with a greater number of thinner components utilized in some situations to reduce the thermal load per component. As illustrated in FIG. 2, each frequency conversion crystal can be enclosed by a sapphire or fused silica window 212/214/216/218 so that the crystals can be cooled with flowing helium gas. In some embodiments, the absorption in the frequency conversion crystals produces a heat load in the crystals that drives the crystal specifications including the thickness of the crystal. The windows 212/214/216/218 may act to channel the cooling gas flow along the crystal surfaces, or may be bonded to the crystal surface and act to draw heat into the cooling gas flow. One of ordinary skill in the art would recognize many variations, modifications, and alternatives. It should be noted that internal windows between each pair of cascaded doubler or tripler crystals may cause a “harmonic interference” effect for the second and third harmonic fields, respectively, due to index of refraction dispersion of the optical glass. For this reason, in embodiments in which internal windows are used in either harmonic module, they are controlled to micron level tolerances on the optical patch length. The same “harmonic interference” effect occurs in the flowing gas coolant, however, the index dispersion is many orders of magnitude less, so short gas lengths (up to several centimeters) can be tolerated. In the space between the first and second conversion modules, the separation can be arbitrary, depending solely on mechanical considerations.

Referring to FIG. 2, the first frequency conversion device 210 changes a predetermined percentage (e.g., a majority) of the 1ω input light polarized along the x-direction from the original frequency to twice the original frequency (i.e., 2ω) with a polarization orthogonal to the original polarization (i.e., 2ω light aligned with the y-direction as illustrated between the first and second frequency conversion devices). A second predetermined percentage of the 1ω input light remains at the original frequency with the original polarization as illustrated between the first and second frequency conversion devices.

The predetermined percentage at the doubled frequency and the second predetermined percentage of the original frequency are converted (i.e., mixed) in the second frequency conversion device 230 to produce a frequency tripled beam (i.e., 3ω) with a polarization aligned with the 1ω input light (i.e., the x-direction) propagating along the beam direction (i.e., the z-direction).

In an alternative embodiment, the first frequency conversion device can include a pair of Type II doublers and the input beam can be oriented at an angle (y) in order to produce the 1ω and 2ω beams between the first and second frequency conversion devices. As will be evident to one of skill in the art, the input beam can include components aligned with both the x-direction and the y-direction as appropriate to Type II doubling (i.e., two-thirds aligned with the y-direction and one-third aligned with the x-direction in this implementation).

As illustrated in FIG. 2, some embodiments convert the second and third harmonics via a cascaded 4-crystal design including two DKDP crystals each for second and third harmonic conversion. In the four crystal implementation illustrated in FIG. 2, each pair of doubler and tripler crystals is rotated 180 degrees about the beam-propagation axis with respect to one another, creating an alternation in the crystal optical axis orientations as shown by arrows 242/244/252/254 in FIG. 2. This implementation can be referred to as alternating-Z. In other embodiments, parallel Z-axis operation is utilized with attention paid to the alternation of sign in the doubler angle-tuning. The inventors have also determined that there is a distinct performance advantage in alternation of the sign in the tripler crystal angle-tuning. Because of the thermal loads associated with high average power operation, the four crystal architectures illustrated herein utilize thin crystals (typically from 5 to 13 mm in thickness), which are well suited for thermal and stress management under high average power operation. They also allow a wide range of incident intensities to be efficiently converted, thereby increasing the dynamic range, as compared to conventional frequency converter designs.

Referring to FIG. 2, the cooling design used in conjunction with the four crystal converter design is illustrated. Windows 212/214, 216/218 and 232/234, 236/238 are provided adjacent each of the frequency conversion crystals to allow for the flow of pressurized helium gas to channel between one surface of the plate and one crystal surface. The windows can be fabricated from a variety of materials including fused silica plates, sapphire plates, or the like. In an alternative embodiment, the window is bonded to the crystal surfaces using a very thin, flexible, “sol gel” type optical contacting or bonding agent, thus allowing the high thermal conductivity plate to act as a “heat spreader.” In these bonded applications, the input surface of the first doubler crystal and last tripler crystal could be preferentially bonded, since these surfaces see the highest thermal load, at 1ω for the doubler and at 3ω for the tripler, as the light is converted. FIG. 2 shows internal windows 214/216 and 234/236, however, due to the “harmonic interference” effect mentioned earlier, some embodiments removed these windows and crystal pairs 211/213 and 231/233 can be closely spaced.

As illustrated in FIG. 2, a continuous random phase plate (CPP) 275 patterned on a substrate such as fused silica can be positioned between (e.g., midway between) the first frequency conversion device 210 and the second frequency conversion device 230. The CPP does not require gas cooling since it transmits only the fundamental and second harmonic beams and is patterned on a transparent optical glass substrate or on one of the cooling channel windows. In most ICF applications, the CPP is utilized as a component useful for the high energy illumination of ICF targets. Additionally, the CPP can be a component of a beam smoothing system for target irradiation utilizing spectral bandwidth and spectral dispersion in some embodiments of the present invention. The CPP is optional in some embodiments depending on the particular applications. In the LIFE design, the CPP serves to homogenize the spatially overlapped focal distributions of the “foot” and “drive” beams and serves to insure that the desired “total” third harmonic pulse shape is incident at the target plane.

Single-crystal sapphire is a highly transparent window material (for wavelengths from 200 nm to over 3 μm), yet is moderately birefringent. Therefore, in some embodiments, sapphire plates are only used on the input face of the first doubler and the exit face of the second doubler in order to avoid additional phase-mismatch. Optically isotropic fused silica plates are used on interior surfaces in some embodiments Similarly, sapphire can be used on the input face of the first tripler or exit face of the last tripler crystal with fused silica utilized as the other windows. The birefringence axes of the sapphire is preferably matched to the polarization directions of the linear polarized fields to avoid depolarization losses. Gas flow cooling between the doublers, between the second doubler and the first tripler, as well as between tripler crystals or optical plates can be provided according to embodiments of the present invention, whether the plates are bonded or mounted separately and used as gas flow channels or gas flow directors.

The inventors have determined that the “cascaded” multi-crystal designs described herein may be impacted by harmonic field interference effects due to index of refraction dispersion in the cooling gas and/or optical window materials present between pairs of frequency doubler and tripler crystals. That is, the harmonic field (2ω) created in the first doubler crystal will optically interfere with the harmonic field (2ω) created in the second doubler, as the phase of the harmonic field in the second doubler is determined by the fundamental field (1ω) phases, and these are retarded relative to the harmonic field created in the first doubler, due to index dispersion in the intervening gas and/or optical plates. A similar effect will occur in the tripler crystal pair, but involve the fundamental field (1ω) and the two harmonic fields (2ω, 3ω). Accordingly, some embodiments of the present invention reduce or minimize the thickness of the gas cooling channels and optical window materials to minimize optical path differences due to dispersion. As mentioned earlier, the same “harmonic interference” effect occurs in the flowing gas coolant, however, the index dispersion is many orders of magnitude less than optical glass, so gas paths (up to several cm) can be tolerated. No harmonic interference will occur between the pair of doubler and pair of tripler crystals, so these can be separated as required by the engineering design of the crystal mounts, or to provide a location for the CPP if utilized, and stepper motor drives (for angle tuning as described below) with intervening optical plates or windows to guide the cooling gas as needed.

Referring once again to FIG. 2, type I or type II phase matching can be utilized for the second harmonic or doubler crystals and type II phase matching is used for the third harmonic or tripler crystals. In some embodiments, type II phase matching is preferred for the doubler since the multi-crystal type II/type II architecture has higher conversion efficiency for the LIFE pulse shape shown in FIG. 1 in comparison with type I phase matched doublers (74.1% vs. 68.8%, respectively). Type I/type II tripling is a phase-matching architecture in DKDP that can tolerate a moderately non-uniform polarization of the 1ω beam. For that reason, it can be used as the tripling architecture. In the LIFE laser design, aggressive birefringence compensation will limit polarization non uniformities, allowing for efficient frequency conversion with either a type I/type II or type II/type II architecture. Thus, embodiments of the present invention can utilize a variety of phase matching architectures.

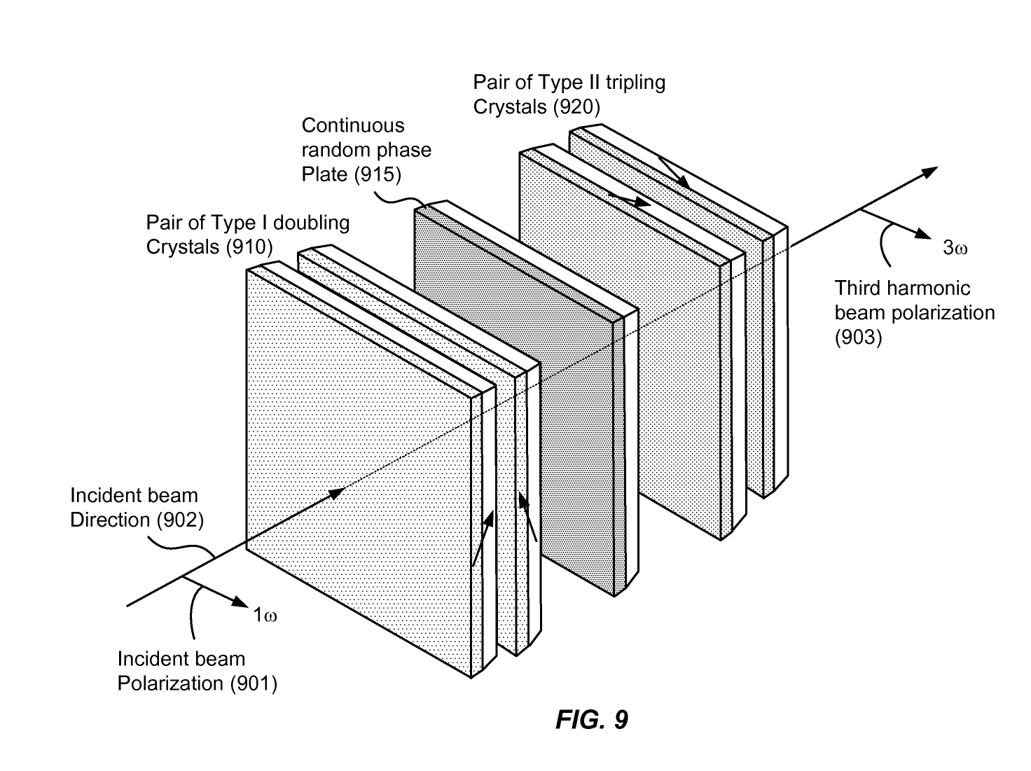

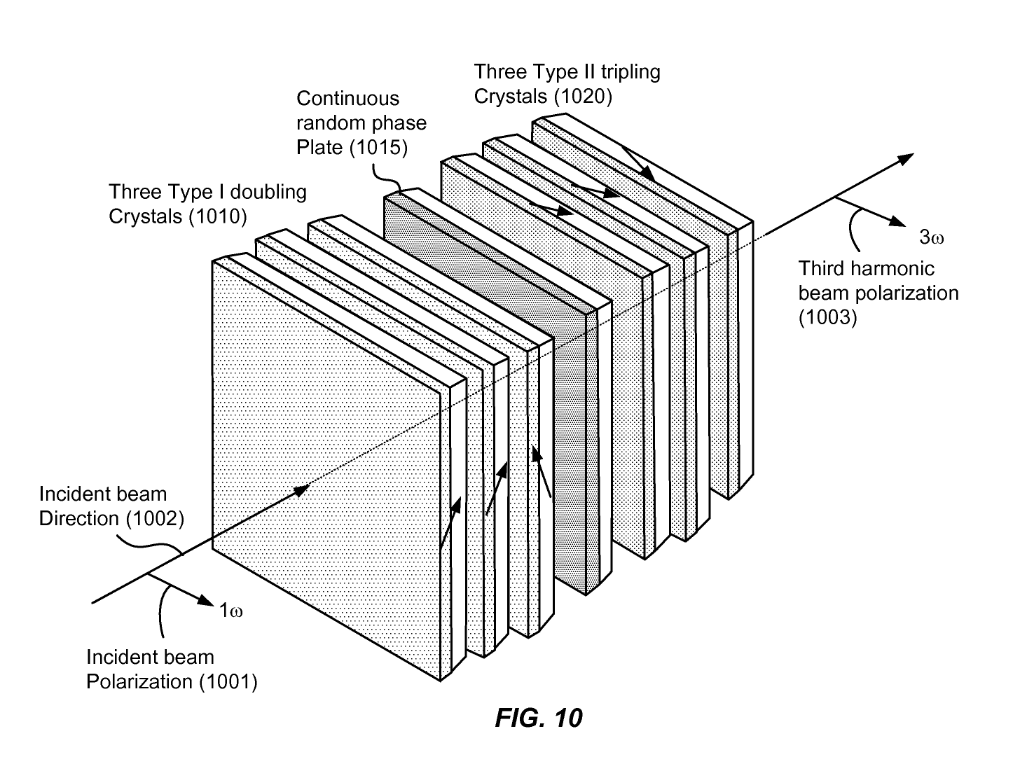

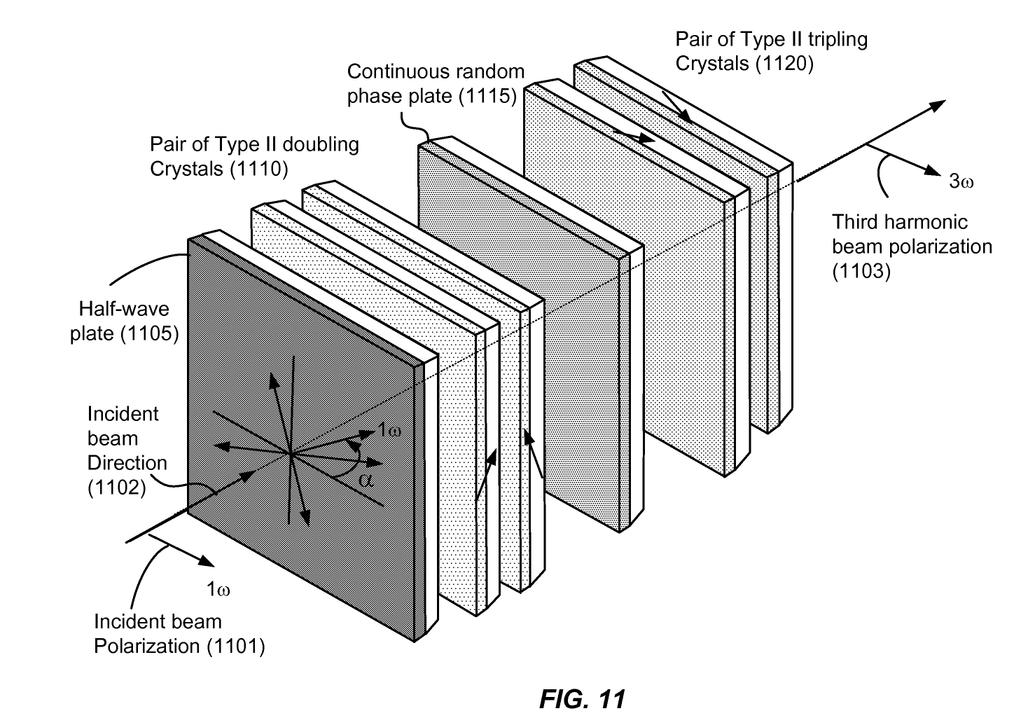

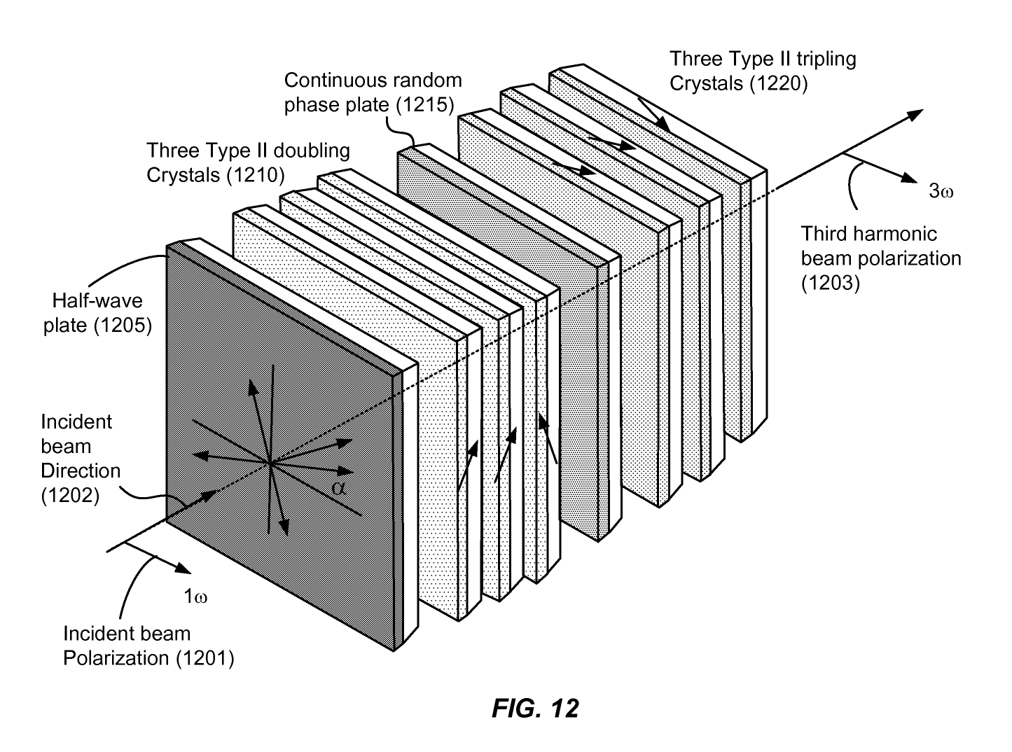

For type I phase matching, the input polarization is linear and along the ordinary axis of the first doubler. As described more fully throughout the present specification, angle tuning (e.g., at large angles) away from ideal phase-matched second harmonic conversion is used in the type I doubling crystals to limit the conversion of the fundamental to the second harmonic, thereby maintaining the predetermined mix ratio for tripling. As described in relation to FIGS. 9 and 10, four and six crystal designs for type I/type II tripling are provided by embodiments of the present invention. For type II phase matched doubling and tripling, on the other hand, the incident fundamental beam is polarized at 35.3° with respect to the ordinary axis of the first doubler crystal. This can be accomplished by either cutting the type II crystals appropriately from the crystal boule so that the 35.3° polarization angle (internal to the crystal) is matched to the incident 1ω polarization direction, or a polarization rotator (such as a half-wave plate made from crystal sapphire, KDP, DKDP, or the like) can be used to match the 1ω polarization direction to the crystal axes as shown in FIG. 2. As described in relation to FIGS. 11 and 12, four and six crystal designs for type II/type II tripling are provided by embodiments of the present invention. As shown in FIGS. 11 and 12, a half-wave plate is utilized ahead of the first doubling crystal. In some embodiments, this half-wave plate can utilize active cooling for temperature control, for example, when the half-wave plate is fabricated from DKDP, and can be co-located within the harmonic converter assembly. Also illustrated in FIGS. 9 through 12 is the concept that the edges of each crystal have a noticeable bevel (˜45 degrees). In actual practice with large aperture (e.g. 40 cm) harmonic converters, this is utilized to help mitigate transverse stimulated Brillioun and Raman scattering.

Introducing an angle between the normal of the crystal surface with respect to the beam propagation direction results in an internal angle between the angle of the beam propagation with respect to the optic axis of the crystals, thereby changing the momentum mismatch between the fields. Thus, embodiments of the present invention, rather than achieving “perfect” phase matching, introduce a tuning angle deviation or so called “detuning” to improve the frequency conversion efficiency.

By detuning the phase matching condition of the doubler, for example, by an internal angle from “perfect” phase matching of between 200 and 300 gad, the double is not allowed to fully convert the fundamental light to the second harmonic, thus enabling the detuning angle to control the ratio of first to second harmonic light at the input of the tripler.

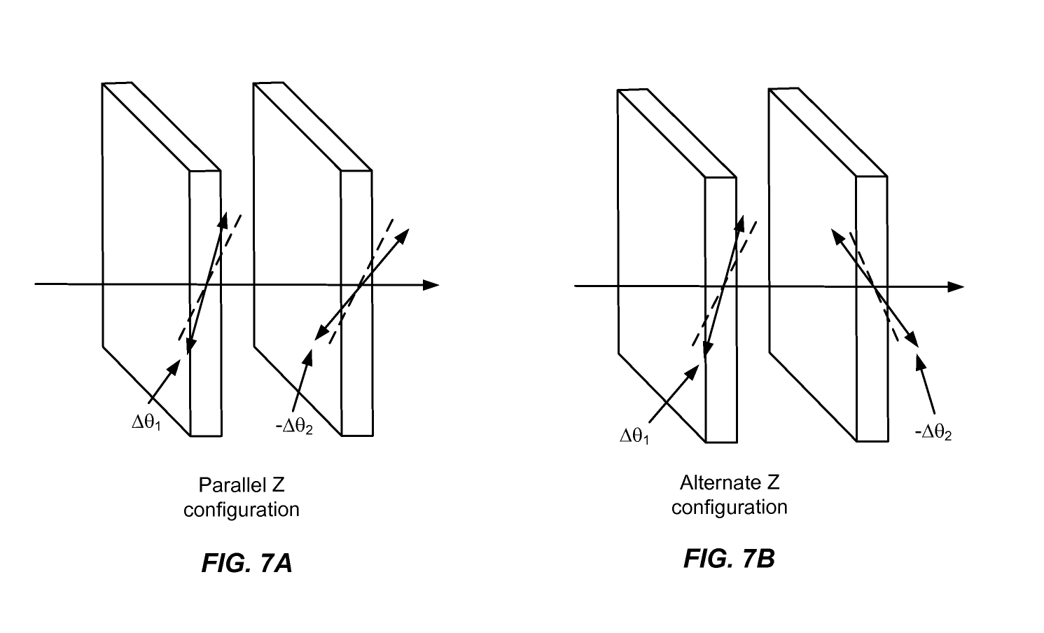

The use of multiple crystals in the doubler and tripler enables the angular detuning to alternate between adjacent crystals. This is shown in FIGS. 7A and 7B. The arrows indicate the direction of the optical C-axes, which are “locked” to the material, while the dotted line is the direction in space of the orientation of the optical axes for perfect phase matching relative to the beam direction. As an example, the first crystal in the doubler could be tuned a few hundred microradians in a first direction, e.g., +Δθ₁, and the second crystal in the doubler could be tuned a few hundred microradians in a second direction opposing the first direction, e.g., −Δθ₂ This is the “parallel-Z” configuration in FIG. 7A. The optical axes can be opposed, while maintaining this alternation in tuning angles, as shown by the “alternate-Z” configuration in FIG. 7B. Both configurations are predicted to be equivalent in performance. The inventors have determined that in the high efficiency systems described herein, a compensating effect occurs in which the phase shifts connected with the harmonic conversion process that are incurred in the first crystal can be compensated as the light propagates through the second and subsequent crystals. As an example, and as discussed below in relation to Table II, the first crystal is detuned at +280 μrad and the second crystal is detuned at −240 μrad in an embodiment. Similarly, the crystals in the tripler are detuned at +30 μrad and −30 μrad, respectively in this embodiment. The particular tuning angles will depend on the particular parameters of the frequency conversion system and the examples given herein are merely for illustrative purposes. The inventors have determined that the staggered tuning actually opens up the angular bandwidth (i.e., the angular acceptance) of the harmonic converter package, providing additional benefits in addition to high conversion efficiency.

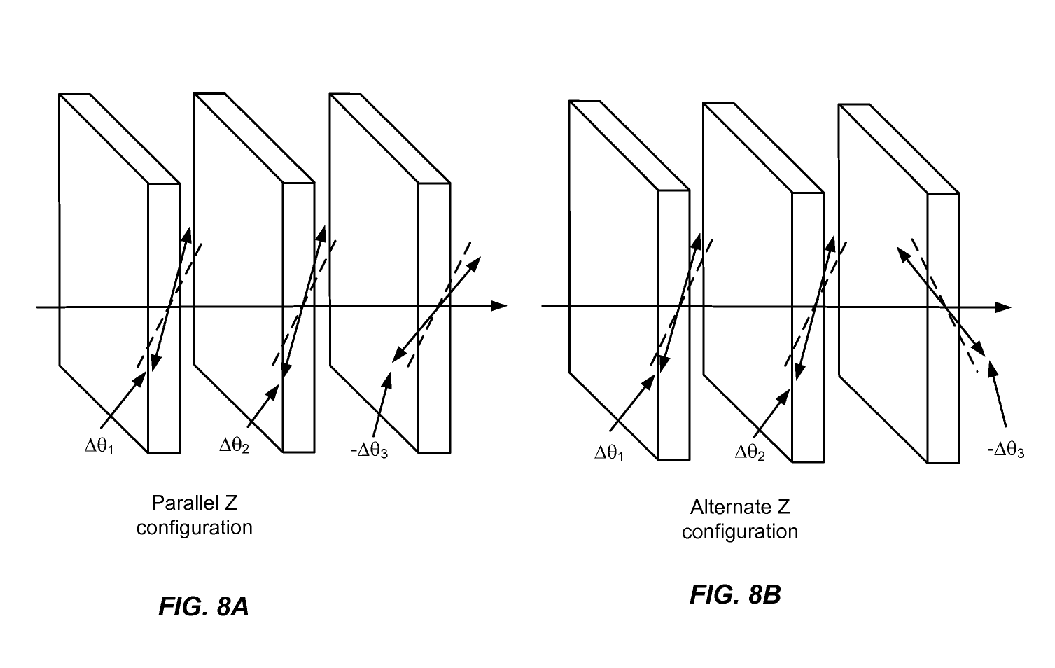

For type II phase matching, the ratio of incident fundamental (lco) intensity along ordinary and extraordinary axes is 2:1. This provides the optimal 1:1 mix ratio of fundamental (1ω) and second harmonic (2ω) light to produce the third harmonic (3ω) in the tripler. For type I phase matching, the 2:1 mix ratio of fundamental to second harmonic light at the exit of the first doubler is achieved by angle tuning the doubler off of exact phase matching (referred to as detuning) by a predetermined angle. In some embodiments, the detuning angle ranges from a few microradians to several hundred microradians. As illustrated below, the detuning angle can vary for each crystal, for example, between 30 μrad and 300 μrad. In four crystal designs utilizing two type I doublers, further increases in dynamic range for frequency mixing in the tripler crystals can be achieved by angle detuning the two doublers in opposite directions (e.g., +280 and −240 μrad). This detuning is a larger amount than would be used in a conventional two-crystal type I/type II converter, since the objective is to achieve a 2:1 mix ratio at the exit of the second doubler (rather than the first doubler) over a wide range of fundamental (1ω) intensity incident on the first doubler. For a “triplet” of doubler crystals, some embodiments “gang” the first and second doublers together, and alternately angle tune the third doubler crystal, as illustrated in FIGS. 8A and 8B, using either parallel-Z or alternating-Z configurations. One of ordinary skill in the art would recognize many variations, modifications, and alternatives.

In a particular embodiment, a tuning error of 30 brad from exact phase matching is allowed in the type II phase matched triplers to account for errors in crystal manufacturing.

The sign of the angular tuning error is reversed depending on the crystal's alternating-Z orientation, for example +30 and −30 μrad, as an alternate-Z tripler is an ordinary tripler rotated by 180 degrees about the beam propagation direction. The inventors have determined that a larger degree of angle tuning of alternating sign between the two tripler crystals will further increase the dynamic range of the four crystal design. The inventors have observed this tripler tuning effect in both type I/type II and type II/type II multi-crystal designs.

The implementations described herein include the phase-mismatch effect of 60 GHz of FM bandwidth imposed on the fundamental (1ω) beam, which is implemented for focal plane beam smoothing and suppression of transverse stimulated Brillouin effects in large aperture ICF lasers. This is accomplished by adding the RMS phase-mismatch from the FM phase modulation on the fundamental (1ω) to the phase-mismatch from all other sources (angle tuning, thermal tuning, crystal bulk and surface distortion, and the like) in a Square-Root of a Sum of Squares method, in both doubler and tripler crystals. The sign of the phase-mismatch is determined by the sign of the angle dependent terms.

Embodiments of the present invention also provide polarization smoothing since a predetermined portion of the beams (e.g., half of the beams) can be provided in a 3ω polarization that is aligned with a first direction (e.g., horizontal) and a second predetermined portion (e.g., the other half of the beams) can be provided in a 3ω polarization that is aligned with a second direction orthogonal to the first direction (e.g., vertical). Providing beams with orthogonal polarizations will result in polarization smoothing at the target since the speckle fields that are generated when the beams overlap on the target add incoherently. Embodiments can implement a polarization rotator (e.g., a DKDP crystal acting as a wave plate) into the doubling and/or tripling architectures or can implement a polarization rotation as a separate optical element. One of ordinary skill in the art would recognize many variations, modifications, and alternatives.

Embodiments of the present invention provide for higher frequency converter energy efficiency that conventional designs. Table I through Table VI list frequency converter parameters and efficiencies for various embodiments of the present invention. Table I through Table IV list parameters and efficiencies for four crystal type I/type II and type II/type II frequency converter architectures. Table V and Table VI list parameters and efficiencies for two crystal type I/type II and type II/type II designs. As is evident from the tables, four crystal designs have greater efficiency in comparison with two crystal designs. As illustrated in the tables, the optimal converter design for the “total” pulse as well as for the architecture where the “foot” and “drive” portions of the pulse are amplified and converted in separated beams are provided. For a given third harmonic pulse shape, the incident pulse shape and required input energy are calculated at the input of the laser amplifier and frequency converter chain. Diffraction and beam quality are accounted for in the 1053-nm laser chain and in the frequency converter. Conversion efficiency can be optimized by changing the crystal lengths and angular tuning. While converter designs can be separately optimized for the “foot” and “drive” beams, the four crystal type II/type II designs for “foot” and “drive” beams listed in Table I use identical crystal lengths of 9 mm and achieve an overall efficiency of 74.1%. Separation of “foot” and “drive” pulses and beams is particularly effective for four-crystal type II/type II converter designs. In the type I/type II architecture, a thicker first doubler is utilized although this is not required by the present invention. It should be noted that the overall efficiency of the four crystal type II/type II architecture can be raised from 60.2% to 68.8% by implementing separate “foot” and “drive” pulse formats and beam mapping.

Table I lists frequency converter parameters for a four crystal type II/type II tripling architecture as illustrated in FIG. 2. The crystal lengths and the angular detuning values are provided as follows: first crystal of the frequency doubler module/second crystal of the frequency doubler module/first crystal of the frequency tripler module/second crystal of the frequency tripler module.

TABLE I

| | | | Drive |
|---|---|---|---|
| | | Foot Portion of | Portion of |
| | Total pulse | Pulse | Pulse |
| Crystal lengths (mm) | 11/11/9.5/9.5 | 9/9/8.5/8.5 | 9/9/8.5/8.5 |
| Angular detuning | 30/−30/30/−30 | 30/−30/30/−30 | 30/−30/30/−30 |
| (μrad) | | | |
| Conversion Efficiency | 66.52% | 68.81% | 77.03% |

Table II lists frequency converter parameters for a four crystal “thick-thin” type I/type II tripling architecture as illustrated in FIG. 2.

TABLE II

| | | | Drive |
|---|---|---|---|
| | | Foot Portion of | Portion of |
| | Total pulse | Pulse | Pulse |
| Crystal | 14/11/10/10 | 13/9/9/9 | 13/9/9/9 |
| lengths (mm) | | | |
| Angular | 280/−240/30/−30 | 280/−240/30/−30 | 280/−240/30/−30 |
| detuning | | | |
| (μrad) | | | |
| Conversion | 61.77% | 62.99% | 72.77% |
| Efficiency | | | |

Table III lists frequency converter parameters for a four crystal “thin-thick” type I/type II tripling architecture as illustrated in FIG. 2.

TABLE III

| | | Foot Portion of | Drive Portion of |
|---|---|---|---|
| | Total pulse | Pulse | Pulse |
| Crystal | 11/13/10/10 | 8/12/8/8 | 8/12/8/8 |
| lengths (mm) | | | |
| Angular | 280/−320/30/−30 | 280/−320/30/−30 | 280/−320/30/−30 |
| detuning | | | |
| (μrad) | | | |
| Conversion | 60.37% | 61.01% | 72.19% |
| Efficiency | | | |

Table IV lists frequency converter parameters for a four crystal “thin-thick” type II/type II tripling architecture as illustrated in FIG. 2.

TABLE IV

| | | | Drive |
|---|---|---|---|
| | | Foot Portion of | Portion of |
| | Total pulse | Pulse | Pulse |
| Crystal lengths (mm) | 10/12/9.5/9.5 | 6/12/8.5/8.5 | 6/12/8.5/8.5 |
| Angular detuning | 30/−30/30/−30 | 30/−30/30/−30 | 30/−30/30/−30 |
| (μrad) | | | |
| Conversion Efficiency | 66.55% | 68.83% | 77.07% |

Table V lists frequency converter parameters for a two crystal type I/type II tripling architecture.

TABLE V

| | | Foot Portion of | Drive Portion of |
|---|---|---|---|
| | Total pulse | Pulse | Pulse |
| Crystal lengths (mm) | 26/18 | 25/16 | 25/16 |
| Angular detuning | 120/30 | 120/30 | 120/30 |
| (μrad) | | | |
| Conversion Efficiency | 54.46% | 61.48% | 66.82% |

Table VI lists frequency converter parameters for a two crystal type II/type II tripling architecture.

TABLE VI

| | | Foot Portion of | Drive Portion of |
|---|---|---|---|
| | Total pulse | Pulse | Pulse |
| Crystal lengths (mm) | 18/18 | 15/15 | 15/15 |
| Angular detuning | 30/30 | 30/30 | 30/30 |
| (μrad) | | | |
| Conversion Efficiency | 56.50% | 60.08% | 67.70% |

The inventors have determined that in order to address thermal management concerns and to reduce the risk of crystal fracture, a thinner first doubler can be utilized, resulting in only a minor loss in conversion efficiency. A typical thin/thick design for a type

I/type II four crystal converter is shown in Table III, while a thin-thick design for a type II/type II converter is shown in Table IV. Further crystal thinning in all designs is possible with some loss in energy conversion efficiency, as is the possibility of adding a third doubler or tripler crystal in order to limit thermal gradients. It is believed that longitudinal thermal gradients are not expected to exceed 0.5° C. for highly deuterated KDP (>98%), which should allow the conversion efficiency for frequency tripling to remain near 70%.

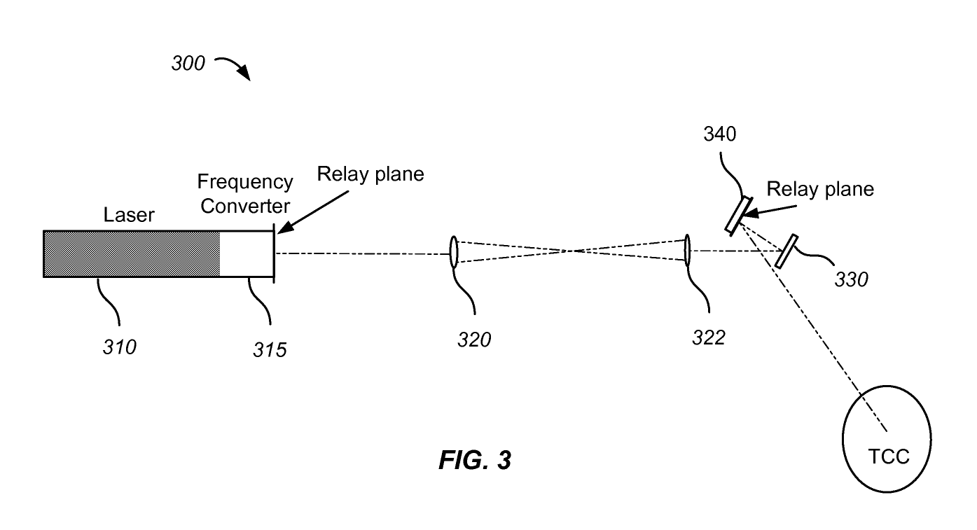

FIG. 3 is a simplified schematic diagram illustrating a laser system utilizing a frequency converter according to an embodiment of the present invention. As illustrated in FIG. 3, the frequency tripled beam (3ω) is relayed over a 20 m long vacuum telescope to a 20 m focal length off-axis parabola for focusing onto a target, which can be located in a target chamber. Light from laser 310 is frequency converted using frequency converter 315, which can utilize the design illustrated in FIG. 2. A relay plane is defined at the output of the frequency converter 315. The frequency tripled light at the output of the frequency converter 315 propagates along an optical path towards lens 320.

In some embodiments, the distance from the relay plane to lens 320 is 640 cm and the distance from lens 320 to lens 322 is 800 cm. In the illustrated embodiment, the focal lengths of lens 320 and lens 322 sum to 2 m (i.e., F1+F2=2000 cm).

Lenses 320 and 322 provide a telescope, which can be operated under vacuum. A neutron baffle can be located at the center of the telescope to prevent propagation of neutrons to portions of the system that can sustain neutron damage.

Light from the telescope reflects off of turning mirror 330 and is reflected off of parabolic minor 340 toward the target chamber (TCC). In some embodiments, the distance from the second lens 322 to the parabolic mirror 340 is 560 cm and the distance from the parabolic mirror 340 to the target chamber is 2000 cm. In some implementations, a combination of a mirror and a Fresnel lens can be substituted for the parabolic mirror 340. The distances given above are provided merely by way of example and other optical configurations can be utilized according to embodiments of the present invention.

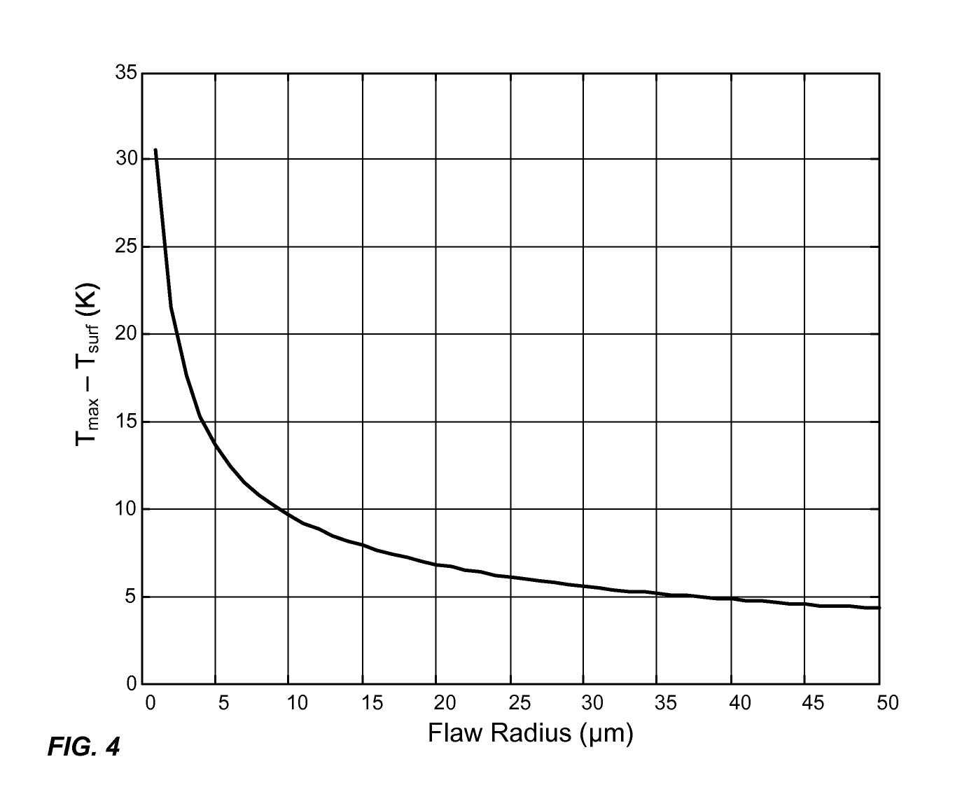

Embodiments of the present invention provide thermal management solutions. The inventors have determined that limiting the crystal thickness results in reductions in the risk of fracture. The temperature difference between the center and face of the crystal is limited by stress-fracture in KDP and the quality of the surface polish. FIG. 4 is a simplified plot illustrating a temperature differential as a function of flaw radius according to an embodiment of the present invention. In the plot, the temperature differential between the center and surface of the crystal (Tₘₐₓ−T_{surf}), where fracture is predicted for DKDP, is shown as a function of flaw radius. The flaw is considered to be a half-penny shaped defect with a given radius for this computation. For system specifications that allow for a 25 μM flaw radius (e.g., NIF specifications), a KDP crystal will fracture at a temperature difference of ˜6.1 K from the mid-plane of the crystal to the entrance or exit surfaces. As an exemplary crystal that can be utilized in the systems described herein, a 1 cm thick KDP crystal will have a fracture limit 3.4 times less than this fracture limit with a temperature difference of 1.8 K, providing for reliable operation. Thicker crystals are split into two crystals in some alternative embodiments or given a more stringent polishing requirement to avoid fracture. Referring to FIG. 4, it should be noted that the maximum allowed temperature gradient can be more than doubled by reducing the flaw size to a 5 μm radius. One of ordinary skill in the art would recognize many variations, modifications, and alternatives.

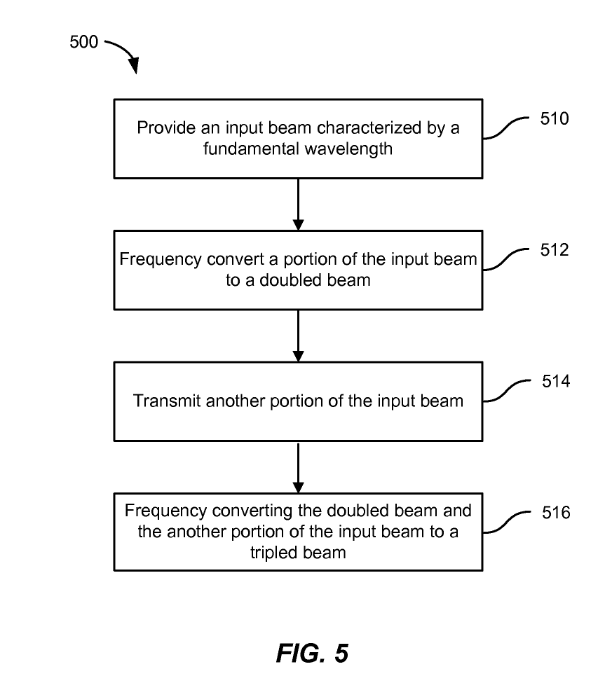

FIG. 5 is a simplified flowchart illustrating a method of generating frequency converted light according to an embodiment of the present invention. The method includes providing an input beam characterized by a fundamental wavelength (510) and frequency converting a portion of the input beam to a doubled beam characterized by a doubled wavelength half the fundamental wavelength (512). Another portion of the input beam is not frequency converted, but transmitted (514). Assuming the losses during frequency conversion are zero, the another portion is equal to a remaining portion of the input beam not frequency converted. Frequency converting the input beam includes transmitting the input beam through a first plurality of non-linear optical crystals (either type I or type II crystals) and outputting the doubled beam and the another portion of the input beam. Frequency converting the portion of the input beam to a doubled beam can include detuning a first crystal of the first plurality of non-linear optical crystals by a first angle and detuning a second crystal of the first plurality of non-linear optical crystals by a second angle. The first angle is measured between a direction of beam propagation and an optic axis of the first crystal in a first direction (e.g., a positive angle) and the second angle is measured between the direction of beam propagation and the optic axis of the second crystal in a second direction opposite to the first direction (e.g., a negative angle) in some embodiments.

The method further includes frequency converting the doubled beam and the another portion of the input beam (e.g., the remaining portion) to a tripled beam characterized by a tripled wavelength two thirds the doubled wavelength (516). Frequency converting the doubled beam and the remaining portion of the input beam includes transmitting the doubled beam light and the remaining portion of the input beam through a second plurality of non-linear optical crystals and outputting the tripled beam. Frequency converting the doubled beam and the remaining portion of the input beam to a tripled beam can include detuning a first crystal of the second plurality of non-linear optical crystals by a third angle and detuning a second crystal of the first plurality of non-linear optical crystals by a fourth angle. The third angle is measured between a direction of beam propagation and an optic axis of the first crystal in a first direction (e.g., a positive angle) and the fourth angle is measured between the direction of beam propagation and the optic axis of the second crystal in a second direction opposite to the first direction (e.g., a negative angle) in some embodiments.

In an embodiment of the present invention, the first plurality of non-linear crystals include DKDP and the second plurality of non-linear crystals include DKDP. Additionally, a method provided by a specific embodiment includes rotating the polarization of at least the doubled beam and the remaining portion of the input beam or the tripled beam.

It should be appreciated that the specific steps illustrated in FIG. 5 provide a particular method of generating frequency converted light according to an embodiment of the present invention. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

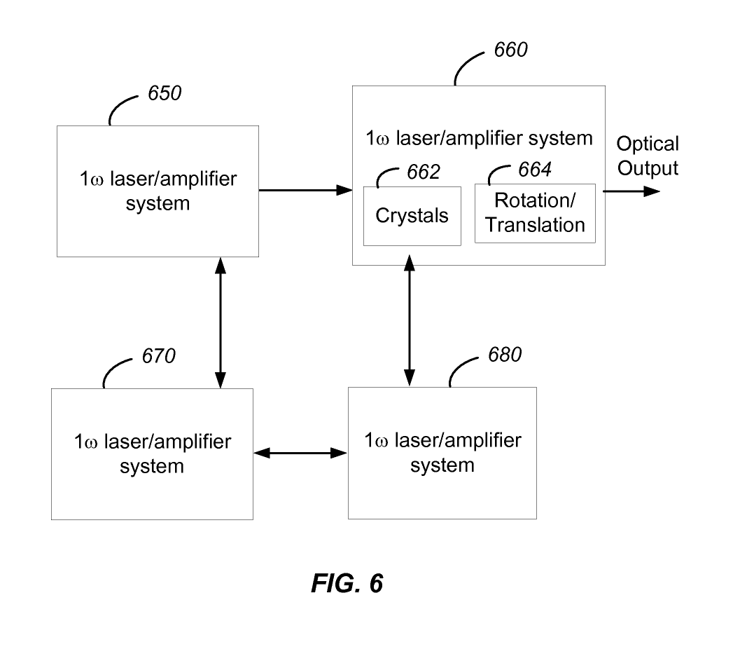

FIG. 6 is a simplified schematic diagram illustrating an optical system according to an embodiment of the present invention. As illustrated in FIG. 6, a 1ω laser or amplifier system 650 is provided with an optical output at 1ω (such a laser/amplifier system can be referred to as a 1ω beam box). As an example, the 1ω system could be a NIF laser beamline, a LIFE beamline, or the like. One or more optical elements including active optical elements are included within the laser/amplifier system 650 as will be evident to one of skill in the art, and previously depicted in FIG. 4. The term “1ω” refers to the fundamental optical frequency of the laser system and includes optical output at a variety of wavelengths depending on the laser gain medium in use.

The optical system also includes a frequency converter 660, which can include one or more frequency conversion elements as illustrated in FIG. 2, including a plurality of crystals 662 and rotation/translation stages 664 operable detune the crystals 662 under control of control system 670. In some embodiments, the optical output produced by the frequency converter 660 is at 2ω and in other embodiments, the optical output is at 3ω. The frequency converter 660 includes nonlinear optical materials, for example, one or more KDP or DKDP (undeuterated, or partially or fully deuterated) crystals or other suitable nonlinear optical elements. One of ordinary skill in the art would recognize many variations, modifications, and alternatives. A control system 670 and a diagnostics system 680 are also provided in communication with the laser or amplifier system and the frequency converter. Control electronics, sensors, and the like are thus included within the scope of the present invention.

In order to detune the crystals as described herein, rotation and/or translation stages or integrated rotation/translation stages can be provided as elements of the frequency conversion system under the control of the control system 670.

FIG. 7A is a simplified schematic diagram illustrating crystal angle tuning in a parallel Z configuration for either a pair of doubling or tripling crystals according to an embodiment of the present invention. In this example, two type I doubling crystals are illustrated. The dashed lines represent the optimum phase matching orientation and the solid lines represent the actual C-axis orientation. The detuning angle between these orientations is illustrated as a positive angle for the first crystal and a negative angle for the second crystal.

FIG. 7B is a simplified schematic diagram illustrating crystal angle tuning in an alternate Z configuration for either a pair of doubling or tripling crystals according to an embodiment of the present invention.

FIG. 8A is a simplified schematic diagram illustrating crystal angle tuning in a parallel Z configuration for either a triplet of doubling or tripling crystals according to an embodiment of the present invention. In this example, three type I doubling crystals are illustrated. The dashed lines represent the optimum phase matching orientation and the solid lines represent the actual C-axis orientation. The detuning angle between these orientations is illustrated as positive angles for the first two crystals of the triplet and a negative angle for the third crystal of the triplet.

FIG. 8B is a simplified schematic diagram illustrating crystal angle tuning in an alternate Z configuration for either a triplet of doubling or tripling crystals according to an embodiment of the present invention. The triplet design illustrated in FIGS. 8A and 8B can be utilized when the crystals in a four crystal harmonic converter design (two doubler crystals and two tripler crystals) are subdivided into a triplet of doubler or a triplet of tripler crystals in order to address thermal stress fracture considerations.

FIG. 9 is a simplified schematic diagram of a four crystal frequency tripling system including type I phase-matched frequency doubling (910) and type II phase-matched tripling (920). The As illustrated in FIG. 9, the third harmonic beam has a polarization 903 parallel to the polarization of the input beam 901 at the fundamental frequency propagating along direction 902. A CPP plate 915 is illustrated in this embodiment, although it is optional in some designs. For purposes of clarity in the illustration, windows utilized for gas cooling are not shown, but could be utilized as appropriate to the particular application.

FIG. 10 is a simplified schematic diagram of a six crystal frequency tripling system including type I phase-matched frequency doubling (1010) and type II phase-matched tripling (1020). As illustrated in FIG. 10, the third harmonic beam has a polarization 1003 parallel to the polarization of the input fundamental beam 1001 propagating along direction 1002. Windows for gas cooling are not shown for purposes of clarity. As shown in FIG. 10, the C-axis orientation of two of the three crystals in the doubler triplet are aligned and the C-axis orientation of two of the three crystals in the tripler triplet are aligned. In other embodiments, the orientations of the crystals can be modified as appropriate to the particular application. An optional CPP plate 1015 is illustrated in FIG. 10.

FIG. 11 is a simplified schematic diagram of a four crystal frequency tripling system including type II phase-matched frequency doubling (1110) and type II phase-matched frequency tripling (1120) according to an embodiment of the present invention. As illustrated in FIG. 11, the third harmonic beam has a polarization 1103 parallel to the polarization of the input fundamental beam 1101 propagating along direction 1102. A half-wave plate 1105, for example, a crystal quartz, sapphire, or DKDP half-wave plate, positioned optically upstream of the frequency doubling module rotates the nominally horizontally polarized input beam to 35.3°. Windows for gas cooling are not shown for purposes of clarity. In the illustrated embodiment, the optical axes of the half-wave plate is set at 17.65° from horizontal (as illustrated by angle α) to rotate the input polarization at the 1 ω frequency to 35.3° as shown in FIG. 11. An optional CPP plate 1115 is illustrated in FIG. 11.

FIG. 12 a simplified schematic diagram of a six crystal frequency tripling system including type II phase-matched frequency doubling (1210) and type II phase-matched frequency tripling (1220) according to an embodiment of the present invention. A half-wave plate 1205, for example, a crystal quartz, sapphire, or DKDP half-wave plate, rotates the nominally horizontally polarized input beam to 35.3°. As discussed in relation to FIG. 11, the optical axes of the half-wave plate is set at 17.65° from horizontal (as illustrated by angle α) to rotate the input polarization at the 1 ω frequency to 35.3°. As illustrated in FIG. 12, the third harmonic beam has a polarization 1203 parallel to the polarization of the input fundamental beam 1201 propagating along direction 1202. Windows for gas cooling are not shown for purposes of clarity. An optional CPP plate 1215 is illustrated in FIG. 11.

Additionally, as discussed in relation to FIG. 10, the C-axis orientation of two of the three crystals in the doubler triplet (1210) are aligned and the C-axis orientation of two of the three crystals in the tripler triplet (1220) are aligned. In other embodiments, the orientations of the crystals can be modified as appropriate to the particular application.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A frequency conversion system comprising:
a frequency doubler module disposed along a beam path and comprising a first plurality of non-linear crystals; and
a frequency tripler module disposed along the beam path and comprising a second plurality of non-linear crystals.

2. The frequency conversion system of claim 1 wherein:
a first crystal of the first plurality of non-linear crystals is detuned by a first angle and a second crystal of the first plurality of non-linear crystals is detuned by a second angle; and
a first crystal of the second plurality of non-linear crystals is detuned by a third angle and a second crystal of the second plurality of non-linear crystals is detuned by a fourth angle.

3. The frequency conversion system of claim 2 wherein:
the first angle is measured between a direction of beam propagation and an optic axis of the first crystal of the first plurality of non-linear crystals in a first direction; and
the second angle is measured between the direction of beam propagation and the optic axis of the second crystal of the first plurality of non-linear crystals in a second direction opposite to the first direction.

4. The frequency conversion system of claim 3 wherein the first angle is a positive angle and the second angle is a negative angle.

5. The frequency conversion system of claim 2 wherein:
the third angle is measured between a direction of beam propagation and an optic axis of the first crystal of the second plurality of non-linear crystals in a first direction; and
the fourth angle is measured between the direction of beam propagation and the optic axis of the second crystal of the second plurality of non-linear crystals in a second direction opposite to the first direction.

6. The frequency conversion system of claim 5 wherein the third angle is a positive angle and the fourth angle is a negative angle.

7. The frequency conversion system of claim 1 further comprising a continuous random phase plate disposed along the beam path between the frequency doubler module and the frequency tripler module.

8. The frequency conversion system of claim 1 wherein:
the frequency doubler module is operable to receive a 1ω beam and output a portion of the 1ω beam and a 2ω beam; and
the frequency tripler module is operable to receive the 1ω beam and the 2ω beam and to output a 3ω beam.

9. The frequency conversion system of claim 1 wherein the first plurality of non-linear crystals comprises at least two type I crystals.

10. The frequency conversion system of claim 1 wherein the first plurality of non-linear crystals comprises at least two type II crystals.

11. The frequency conversion system of claim 1 wherein the second plurality of non-linear crystals comprise a set of type II crystals.

12. The frequency conversion system of claim 11 wherein the set of type II crystals comprises three crystals.

13. The frequency conversion system of claim 1 wherein the first plurality of non-linear crystals comprises DKDP and the second plurality of non-linear crystals comprise DKDP.

14. The frequency conversion system of claim 1 further comprising a polarization rotator.

15. The frequency conversion system of claim 14 wherein the polarization rotator comprises a DKDP half-wave plate.

16. The frequency conversion system of claim 1 wherein at least one of the frequency doubler module or the frequency tripler module comprises a set of three non-linear optical crystals, wherein a thickness of a first crystal of the set of three non-linear optical crystals is less than a thickness of a second crystal of the set of three non-linear optical crystals.

17. A method of generating frequency converted light, the method comprising:
providing an input beam characterized by a fundamental wavelength;
frequency converting a portion of the input beam to a doubled beam characterized by a doubled wavelength half the fundamental wavelength, wherein frequency converting the input beam comprises transmitting the input beam through a first plurality of non-linear optical crystals and outputting the doubled beam and another portion of the input beam; and
frequency converting the doubled beam and the another portion of the input beam to a tripled beam characterized by a tripled wavelength two thirds the doubled wavelength, wherein frequency converting the doubled beam and the remaining portion of the input beam comprises transmitting the doubled beam light and the remaining portion of the input beam through a second plurality of non-linear optical crystals and outputting the tripled beam.

18. The method of claim 17 wherein frequency converting a portion of the input beam to a doubled beam comprises:
detuning a first crystal of the first plurality of non-linear optical crystals by a first angle; and
detuning a second crystal of the first plurality of non-linear optical crystals by a second angle.

19. The method of claim 18 wherein:
the first angle is measured between a direction of beam propagation and an optic axis of the first crystal in a first direction; and
the second angle is measured between the direction of beam propagation and the optic axis of the second crystal in a second direction opposite to the first direction.

20. The method of claim 19 wherein the first angle is a positive angle and the second angle is a negative angle.

21. The method of claim 17 wherein frequency converting the doubled beam and the remaining portion of the input beam to the tripled beam comprises:
detuning a first crystal of the second plurality of non-linear optical crystals by a third angle; and
detuning a second crystal of the second plurality of non-linear optical crystals by a fourth angle.

22. The method of claim 21 wherein:
the third angle is measured between a direction of beam propagation and an optic axis of the first crystal in a first direction; and
the fourth angle is measured between the direction of beam propagation and the optic axis of the second crystal in a second direction opposite to the first direction.

23. The method of claim 22 wherein the third angle is a positive angle and the fourth angle is a negative angle.

24. The method of claim 17 wherein the first plurality of non-linear crystals comprise a set of two or more type I crystals.

25. The method of claim 17 wherein the first plurality of non-linear crystals comprise a set of two or more type II crystals.

26. The method of claim 17 wherein the second plurality of non-linear crystals comprise a set of two or more type II crystals.

27. The method of claim 17 wherein the first plurality of non-linear crystals comprises DKDP and the second plurality of non-linear crystals comprise DKDP.

28. The method of claim 17 further comprising rotating the polarization of at least the doubled beam and the remaining portion of the input beam or the tripled beam.

29. An optical system comprising:
a laser source operable to output a laser beam at a fundamental wavelength;
a frequency conversion system including:
a frequency doubler module including a first plurality of nonlinear optical crystals; and
a frequency tripler module including a second plurality of nonlinear optical crystals;
a control system coupled to the frequency conversion system; and
a diagnostics system coupled to the frequency conversion system.

30. The optical system of claim 29 wherein the frequency doubler module further comprises a first plurality of rotation stages, each of the first plurality of rotation stages being operable to rotate one of the first plurality of nonlinear optical crystals.

31. The optical system of claim 29 wherein the frequency tripler module further comprises a second plurality of rotation stages, each of the second plurality of rotation stages being operable to rotate one of the second plurality of nonlinear optical crystals.

32. The optical system of claim 29 wherein the frequency conversion system further comprises a CPP plate disposed between the frequency doubler module and the frequency tripler module.

33. The optical system of claim 29 wherein first plurality of nonlinear optical crystals comprise DKDP crystals and the second plurality of nonlinear optical crystals comprise DKDP crystals.

34. The optical system of claim 29 wherein the frequency conversion system further comprises a half wave plate optically upstream of the frequency doubler module.
